(19) United States
(12) Patent Application Publication
(10) Pub. No.: US 2017/0361865 A1
(43) Pub. Date: Dec. 21, 2017

(54) Multiple Piece Pinion Housing For Vehicle Power Steering

(71) Applicant: TRW Automotive U.S. LLC, Livonia, MI (US)

(72) Inventors: Gaurav Krishnaraj, Shelby Township, MI (US); Libin John, Rochester, MI (US)

(73) Assignee: TRW Automotive U.S. LLC, Livonia, MI (US)

(21) Appl. No.: 15/185,300

(22) Filed: Jun. 17, 2016

(51) Int. Cl. B62D 3/12; B62D 5/04; B62D 5/22; B21K 1/26; B21D 26/031; B22D 25/02; B22D 21/04

(52) U.S. Cl. CPC B62D 3/12; B21K 1/26; B62D 5/0448; B21D 26/031; B62D 5/22; B22D 21/04; B22D 25/02

(57) ABSTRACT

A vehicle power steering assembly has a pinion housing comprised of first, second, and third housings. The first housing is a drawn tube formed from a first material. The second housing is a casting formed from a second material. The third housing is a stamping formed from a third material. The second housing is press fit into the first housing. The third housing is press fit and welded to the first housing. The second material has a lesser unit weight than each of the first and third materials. The first, second, and third housings together form the pinion housing.

### BACKGROUND OF INVENTION

This invention relates in general to vehicle power steering assemblies and in particular to a multiple piece pinion housing for use in such a vehicle power steering assembly.

Automotive vehicles typically include a power steering assembly to assist in turning steerable wheels of the vehicle. The power steering assembly will typically include a rack and pinion assembly to convert rotational movement of a steering wheel of the vehicle into linear movement to effect turning of the steerable wheels. The rack and pinion assembly includes a pinion that is held within a pinion housing. Typically, the pinion housing comprises a pinion tower, a tube portion housing the rack, and a belt housing, all of which are formed monolithically as a unitary casting for efficiency during fabrication and subsequent assembly.

Multiple piece pinion housings for hydraulic power steering systems have been fabricated as a hollow tube connecting a cast pinion tower and a cast belt housing. However, the cast belt housing is heavy and significantly increases vehicle weight. To reduce vehicle weight, the pinion housing may be cast from aluminum. However, casting of the pinion housing requires an extended period of time for the molten aluminum to enter and flow throughout a mold for the large and complex casting. The molten aluminum cools during the extended period of time. As molten aluminum cools, air cavities or voids form. The air cavities increase porosity for the cast pinion housing. Thus it would be desirable to have a lighter weight pinion housing with reduced porosity.

### SUMMARY OF INVENTION

This invention relates to a multiple piece pinion housing for a vehicle power steering assembly.

According to one embodiment, a method of fabricating a pinion housing for a vehicle power steering assembly may comprise, individually and/or in combination, one or more of the following features: forming a first housing from a first material, forming a second housing from a second material, and forming a third housing from a third material. The third housing is a stamping. The second material has a lesser unit weight than the first material and the third material has a greater unit weight than the second material. The first, second, and third housings are each formed separately. The formed first, second, and third housings are joined together to form the pinion housing.

According to another embodiment, a pinion housing for a vehicle power steering assembly may comprise, individually and/or in combination, one or more of the following features: A first housing formed from a first material, a second housing formed from a second material, and a third housing stamped from a third material. The second material has a lesser unit weight than the first material and the third material has a greater unit weight than the second material. The first, second, and third housings are each formed separately and joined together to form the pinion housing.

According to another embodiment, a pinion housing for a vehicle power steering assembly may comprise, individually and/or in combination, one or more of the following features: a plurality of housings formed separately and joined together to form the pinion housing. The plurality of housings includes at least a stamped housing and a cast housing. The cast housing has a lesser material unit weight than the stamped housing.

An advantage of an embodiment is a lighter weight pinion housing with reduced porosity. Other advantages of this invention will become apparent to those skilled in the art from the following detailed description of the preferred embodiments, when read in light of the accompanying drawings.

### BRIEF DESCRIPTION OF DRAWINGS

FIG. 1 is a schematic view of a vehicle power steering assembly having a first embodiment of a pinion housing in accordance with the present invention.

FIG. 2 is an exploded perspective view of the pinion housing of FIG. 1.

FIG. 3 is a flow chart of a method for fabricating the pinion housing of FIG. 1.

FIG. 4 is a second embodiment of a pinion housing in accordance with the present invention.

FIG. 5 is a flow chart of a method for fabricating the pinion housing of FIG. 4.

FIG. 6 is a third embodiment of a pinion housing in accordance with the present invention.

FIG. 7 is a flow chart of a method for fabricating the pinion housing of FIG. 6.

### DETAILED DESCRIPTION OF THE PREFERRED EMBODIMENTS

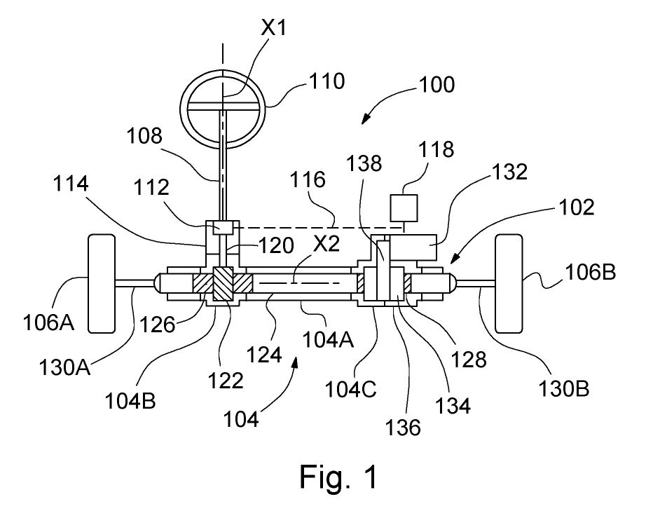

Referring now to FIG. 1, there is schematically illustrated a portion of a vehicle power steering assembly, indicated generally at 100. The general structure and operation of the power steering assembly 100 is conventional in the art. For example, the power steering assembly 100 may be as disclosed by U.S. Pat. No. 7,055,646 to Bugosh, the disclosure of which is hereby incorporated by reference in entirety herein. Thus, only those portions of the power steering assembly 100 which are necessary for a full understanding of this invention will be explained and illustrated in detail. Although this invention will be described and illustrated in connection with the particular power steering assembly 100 disclosed herein, it will be appreciated that this invention may be used in connection with other vehicle power steering assemblies, including other electric, hydraulic, or otherwise powered power steering assemblies known to those skilled in the art.

The power steering assembly 100 is partially housed in a housing, indicated generally at 102. The housing 102 includes a portion that is a first embodiment of a pinion housing, indicated generally at 104, produced in accordance with the present invention. The pinion housing 104 is comprised of a first housing or sub-housing 104A, a second housing or sub-housing 104B, and a third housing or sub-housing 104C, all of which will be discussed further. The housing 102 has further portions that will be discussed.

The power steering assembly 100 is associated with first and second front steerable wheels 106A and 106B, respectively, of a vehicle and includes a rotatable input shaft 108. A vehicle steering wheel 110 is operatively coupled to the input shaft 108 for rotation therewith about a steering axis X1. A torque sensor 112 encircles the input shaft 108 and is located within a pinion tower cover 114 connected to the second housing 104B. For example, the pinion tower cover 114 may be bolted to the second housing 104B. The torque sensor 112 generates signals in response to rotation of the input shaft 108. The signals are transmitted over a data network 116 to an electronic control unit (ECU) 118. The signals indicate a direction and magnitude of steering torque applied to the steering wheel 110.

A torsion bar 120 connects the input shaft 108 to a pinion 122 disposed in the second housing 104B such that the second housing 104B houses or encloses the pinion 122. The torsion bar 120 twists in response to the steering torque applied to the steering wheel 110. When the torsion bar 120 twists, relative rotation occurs between the input shaft 108 and the pinion 122.

The second housing 104B is attached to the first housing 104A in a manner which will be discussed. A linearly moveable steering member 124 extends axially through, and is disposed in, the first housing 104A such that the first housing 104A houses or encloses the steering member 124. The steering member 124 is linearly, or axially, moveable along a rack axis X2. A rack portion 126 of the steering member 124 is provided with a series of rack teeth which meshingly engage gear teeth provided on the pinion 122. The steering member 124 further includes a screw portion 128 having an external screw thread convolution. The steering member 124 is connected to the first steerable wheel 106A by a first tie rod 130A and the second steerable wheel 106B by a second tie rod 130B. The first and second tie rods 130A and 130B, respectively, are located at distal ends of the steering member 124. Linear movement of the steering member 124 along the rack axis X2 results in steering movement of the first and second steerable wheels 106A and 106B, respectively, in a known manner.

The power steering assembly 100 further includes a power source 132 drivably connected to a ball nut assembly 134 housed between the third housing 104C and a ball nut portion 136 of the housing 102. The power source 132 is illustrated as an electric motor, but may be other than an electric motor. For example, the power source 132 may be a hydraulic system. The ECU 118 controls the power source 132 in accordance with the signals received from the torque sensor 112. Control signals are transmitted from the ECU 118 to the power source 132 via the data network 116.

The ball nut assembly 134 is operatively connected with the screw portion 128 of the steering member 124. The power source 132 and ball nut assembly 134 are operatively connected by a pulley assembly 138 that includes a belt between an output of the power source 132 and the ball nut assembly 134. The pulley assembly 138 is disposed in the third housing 104C such that the pulley assembly is at least partially enclosed or housed by the third housing 104C.

Rotation of the pulley assembly 138 causes the ball nut assembly 134 to be rotated and thereby produce linear movement of the steering member 124. The power source 132 rotates the pulley assembly 138 which in turn transmits the drive force of the power source 132 to a ball nut of the ball nut assembly 134. Because the ball nut is fixed in position on the rack axis X2, the steering member 124 is driven to move linearly in response to rotation of the ball nut to, as discussed, effect steering movement of the first and second steerable wheels 106A and 106B, respectively, of the vehicle. The power source 132 thus provides steering assist in response to the applied steering torque.

In the event of the inability of the power source 132 to effect linear movement of the steering member 124, the mechanical connection between the gear teeth on the pinion 122 and the rack teeth on the rack portion 126 permits manual steering of the vehicle.

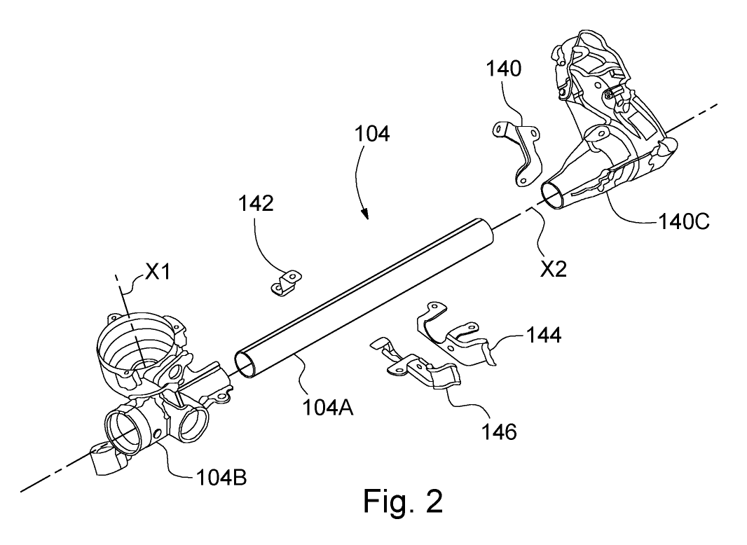

Referring now to FIG. 2, there is illustrated the first, second, and third housings 104A, 104B, and 104C, respectively, of the pinion housing 104. Also illustrated are first, second, third, and fourth mounting brackets 140, 142, 144, and 146, respectively, for the pinion housing 104.

The first housing 104A is formed from a first material, the second housing 104B is formed from a second material, and the third housing 104C is formed from a third material. The first and third materials have a greater unit weight than the second material. For example, the first material may be a first grade of steel, the second material may be aluminum, and the third material may be a second grade of steel. Alternatively, the first and third materials may be the same grade of steel. Alternatively, the first material may be aluminum, plastic, or a polymer. Alternatively, the third material may be a high strength plastic

As illustrated, the first housing 104A is a drawn tube, the second housing 104B is a casting, and the third housing 104C is a stamping. Alternatively, the first housing 104A, the second housing 104B, or the third housing 104C may be formed using different methods—i.e., different than drawing for the first housing 104A, casting for the second housing 104B, or stamping for the third housing 104C—known to those skilled in the art. Each of the first, second, and third housings 104A, 104B, and 104C, respectively, is formed separately.

The pinion housing 104 is formed when the first, second, and third housings 104A, 104B, and 104C, respectively, are joined together. The second housing 104B is joined to the first housing 104A. For example, the first housing 104A may be press fit into the second housing 104B. The first housing 104A is also joined to the third housing 104C. For example, the first housing 104A may be press fit and welded to the third housing 104C.

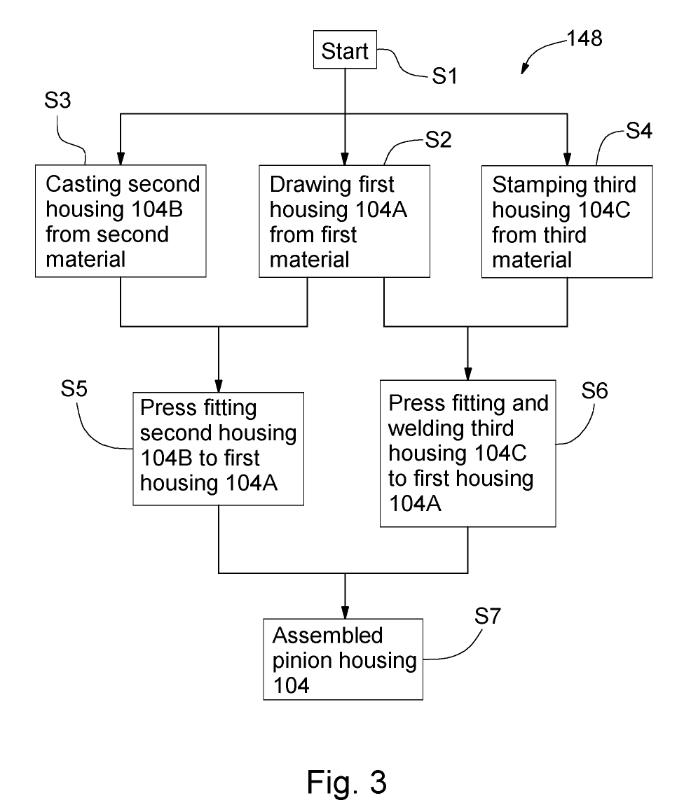

Referring now to FIG. 3, there is illustrated a method, indicated generally at 148, of fabricating the pinion housing 104. The method 148 begins with a step S1. In a step S2, the first housing 104A is drawn from the first material. In a step S3, the second housing 104B is cast from the second material. In a step S4, the third housing 104C is stamped from the third material. In a step S5, the second housing 104B is joined to the first housing 104A and, in a step S6, the third housing 104C is joined to the first housing 104A. In a step S7, the pinion housing 104 is in an assembled state.

As illustrated and discussed, the pinion housing 104 is comprised of three pieces: the first, second, and third housings 104A, 104B, and 104C, respectively. Alternatively, the pinion housing 104 may be comprised of more or fewer than three pieces.

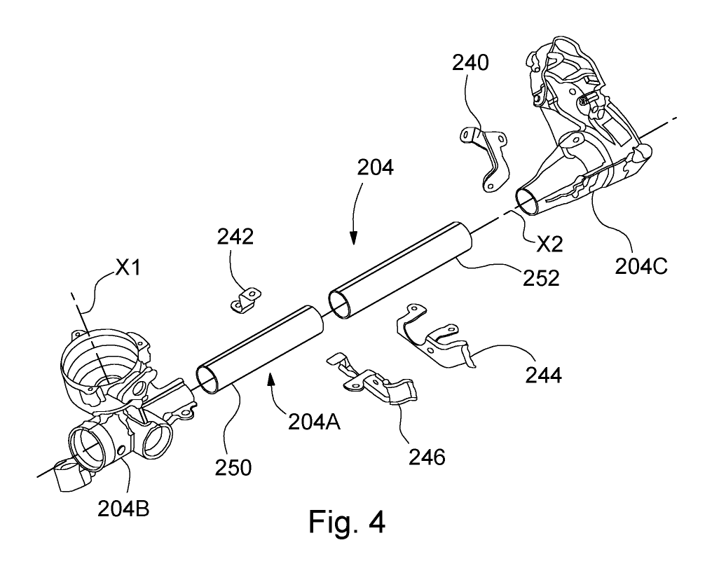

Referring now to FIG. 4, there is illustrated a second embodiment of a pinion housing, indicated generally at 204, produced in accordance with the present invention. Because the pinion housing 204 is a variation of the pinion housing 104 of FIGS. 1 and 2, like reference numerals, increased by 100, designate corresponding parts in the drawings and detailed description thereof will be omitted.

The pinion housing 204 has a first housing or sub-housing, indicated generally at 204A, that is comprised of a first tube 250 and a second tube 252. The first and second tubes 250 and 252, respectively, are formed separately and joined together to form the first housing 204A. For example, the first and second tubes 250 and 252, respectively, may be welded, bolted, or riveted together to form the first housing 204A.

As illustrated, the first and second tubes 250 and 252, respectively, are separately drawn tubes. Alternatively, the first and second tubes 250 and 252, respectively, may be tubes formed other than by drawing. The first tube 250 is formed from a fourth material and the second tube 252 is formed from a fifth material that may be the same as the fourth material. The fourth and fifth materials each have greater unit weights than a second material from which a second housing or sub-housing 204B is formed. For example, the fourth and fifth materials may be steel of either the same of different grades. Alternatively, the fourth and fifth materials may each be aluminum, plastic, or a polymer.

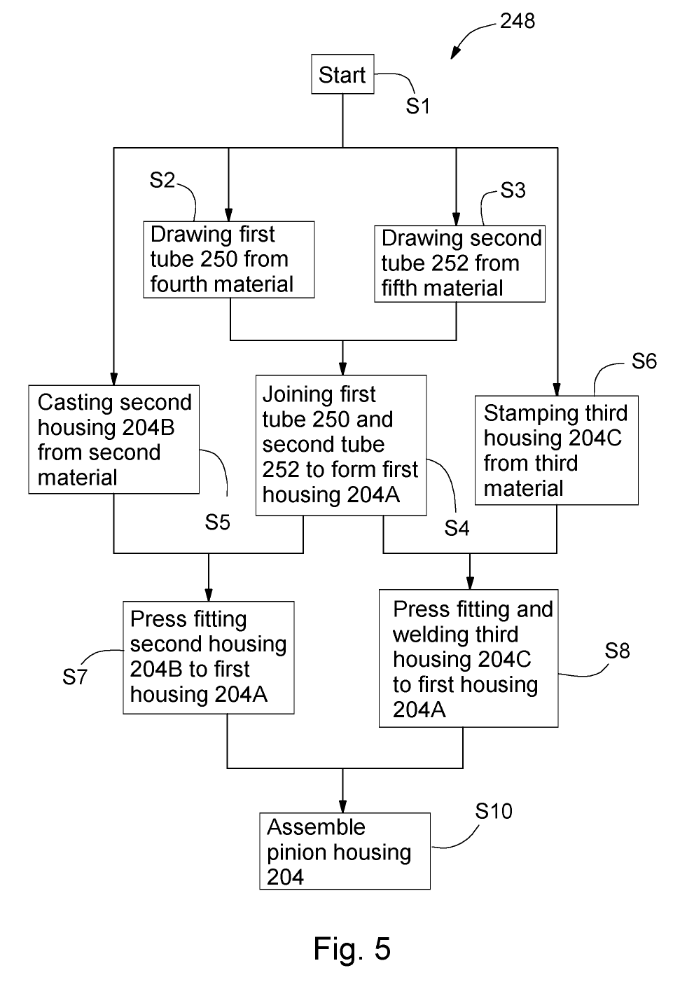

Referring now to FIG. 5, there is illustrated a method, indicated generally at 248, of fabricating the pinion housing 204. The method 248 begins with a step S1. In a step S2, the first tube 250 is drawn from the fourth material and, in a step S3, the second tube 252 is drawn from the fifth material. In a step S4, the first and second tubes 250 and 252, respectively, are joined to form the first housing 204A. In a step S5, the second housing 204B is cast from the second material. In a step S6, a third housing or sub-housing 204C is stamped from a third material. In a step S7, the second housing 204B is joined to the first housing 204A and, in a step S8, the third housing 204C is joined to the first housing 204A. For example, the first housing 204A may be press fit to the second housing 204B and press fit and welded to the third housing 204C. In a step S9, the pinion housing 204 is in an assembled state.

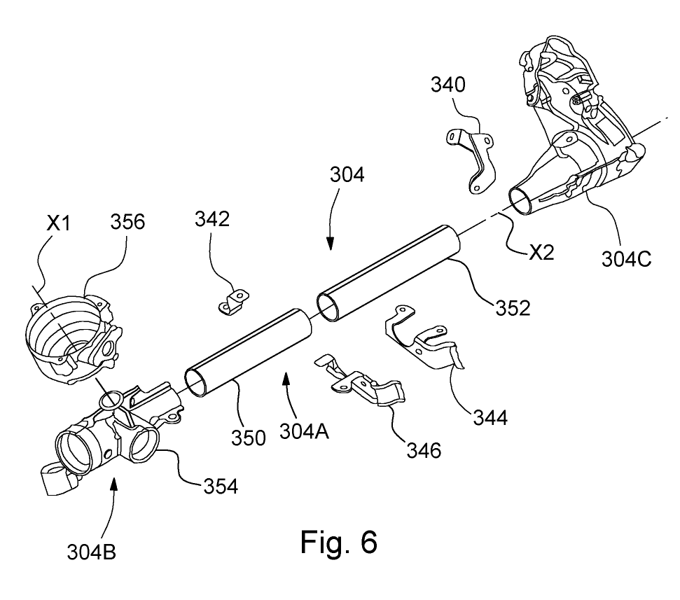

Referring now to FIG. 6, there is illustrated a third embodiment of a pinion housing, indicated generally at 304, produced in accordance with the present invention. Because the pinion housing 304 is a variation of the pinion housing 204 of FIG. 4, like reference numerals, increased by 100, designate corresponding parts in the drawings and detailed description thereof will be omitted.

The pinion housing 304 has a second housing or sub-housing, indicated generally at 304B, that is comprised of a bottom portion 354 and a top portion 356. For example, the bottom portion 354 may be a pinion tower bottom and the top portion 356 may be a pinion bowl. The bottom portion 354 is formed separately from the top portion 356. For example, the bottom portion 354 may be cast separately from casting of the top portion 356. The bottom portion 354 is formed from a sixth material and the top portion 356 is formed from a seventh material. The sixth and seventh materials may be the same or different. For example, each of the sixth or seventh materials may be steel, aluminum, plastic, or a polymer. The bottom portion 354 and top portion 356 are joined together to form the second housing 304B. For example, the bottom portion 354 and top portion 356 may be joined by a threaded connection, rivets, bolts, thermal fusion, or chemically.

As illustrated, the pinion housing 304 has a first tube 350, a second tube 352, the bottom portion 354, and the top portion 356, wherein the first and second tubes 350 and 352, respectively, comprise a first housing or sub-housing 304A. However, the first housing 304A may alternatively be formed as a single component—i.e., similar to the first housing 104A.

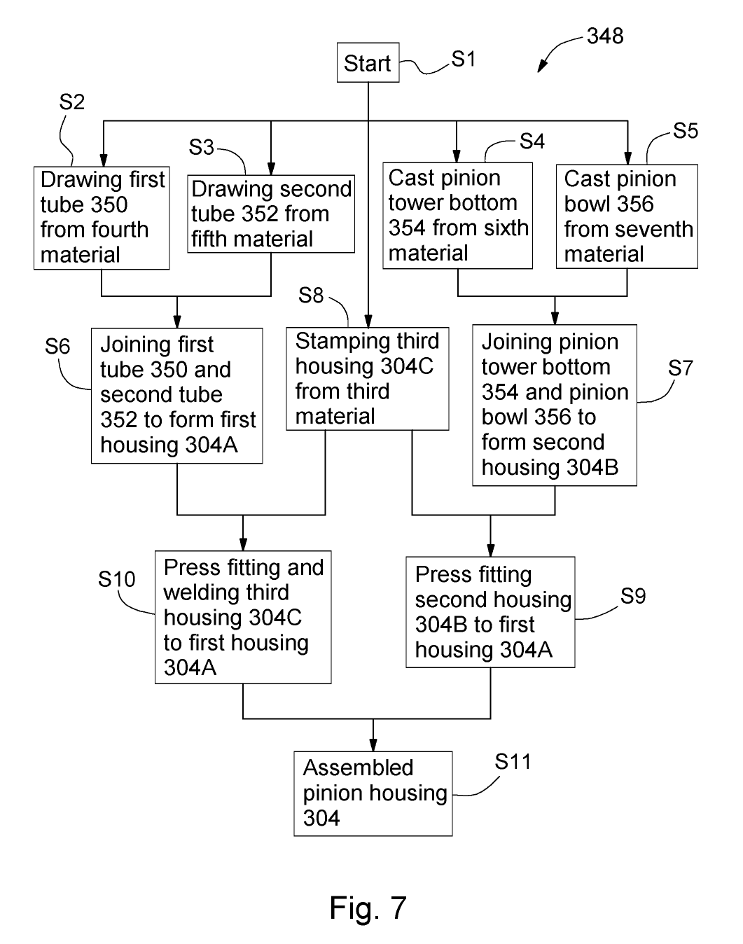

Referring now to FIG. 7, there is illustrated a method, indicated generally at 348, of fabricating the pinion housing 304. The method 348 begins with a step S1. In a step S2, the first tube 350 is drawn from a fourth material and, in a step S3, the second tube 352 is drawn from a fifth material. In a step S4, the bottom portion 354 is cast from the sixth material and, in a step S5, the top portion 356 is cast from the seventh material. In a step S6, the first and second tubes 350 and 352, respectively, are joined to form the first housing 304A. In a step S7, the bottom portion 354 and top portion 356 are joined to form the second housing 304B. In a step S8, a third housing or sub-housing 304C is stamped from a third material. In a step S9, the second housing 304B is joined to the first housing 304A and, in a step S10, the third housing 304C is joined to the first housing 304A. For example, the first housing 304A may be press fit to the second housing 304B and press fit and welded to the third housing 304C. In a step S11, the pinion housing 304 is in an assembled state.

In accordance with the provisions of the patent statutes, the principle and mode of operation of this invention have been described and illustrated in its preferred embodiments. However, it must be understood that this invention may be practiced otherwise than as specifically explained and illustrated without departing from its spirit or scope.

What is claimed is:

1. A method of fabricating a pinion housing for a vehicle power steering assembly, the method comprising the steps of:
forming a first housing from a first material;
forming a second housing from a second material, wherein the second material has a lesser unit weight than the first material;
forming a third housing from a third material, wherein the third housing is a stamping and the third material has a greater unit weight than the second material; and
joining the formed first, second, and third housings together to form the pinion housing, wherein the first, second, and third housings are each formed separately.

2. The method of claim 1 further comprising the steps of:
forming a first tube;
forming a second tube separately from the first tube; and
joining the formed first and second tubes together to form the first housing.

3. The method of claim 1 further comprising the steps of:
forming a pinion tower bottom;
forming a pinion bowl separately from the pinion tower bottom; and
joining the formed pinion tower bottom and formed pinion bowl together to form the second housing.

4. The method of claim 1 wherein the first housing is a drawn tube and the second housing is a casting.

5. The method of claim 1 wherein the first and third materials are steel and the second material is aluminum.

6. A pinion housing for a vehicle power steering assembly, the pinion housing comprising:
a first housing formed from a first material; and
a second housing formed from a second material, wherein the second material has a lesser unit weight than the first material;
a third housing stamped from a third material, wherein the third material has a greater unit weight than the second material, wherein the first, second, and third housings are each formed separately and joined together to form the pinion housing.

7. The pinion housing of claim 6 further comprising:
a first tube; and
a second tube formed separately from the first tube, wherein the first and second tubes are joined together to form the first housing.

8. The pinion housing of claim 6 further comprising:
a pinion tower bottom; and
a pinion bowl formed separately from the pinion tower bottom, wherein the pinion tower bottom and pinion bowl are joined together to form the second housing.

9. The pinion housing of claim 6 wherein the first housing is a drawn tube and the second housing is a casting.

10. The pinion housing of claim 6 wherein the first and third materials are steel and the second material is aluminum.

11. The pinion housing of claim 6 further comprising:
a steering member disposed in the first housing;
a pinion disposed in the second housing, wherein the pinion is operatively connected to a rack portion of the steering member; and
a pulley assembly disposed in the third housing, wherein the pulley assembly operatively connects a power source to a ball nut assembly and the ball nut assembly is operatively connected to a screw portion of the steering member.

12. A pinion housing for a vehicle power steering assembly, the pinion housing comprising:
a plurality of housings formed separately and joined together to form the pinion housing, wherein the plurality of housings includes at least:
a stamped housing; and
a cast housing, wherein the cast housing has a lesser material unit weight than the stamped housing.

13. The pinion housing of claim 12 wherein the stamped housing is formed from steel and the cast housing is formed from aluminum.

14. The pinion housing of claim 12 further comprising:
a steering member disposed in the plurality of housings;
a pinion disposed in the cast housing, wherein the pinion is operatively connected to a rack portion of the steering member; and
a pulley assembly disposed in the stamped housing, wherein the pulley assembly operatively connects a power source to a ball nut assembly and the ball nut assembly is operatively connected to a screw portion of the steering member.

15. The pinion housing of claim 12 wherein the plurality of housings further includes a tube housing between the stamped housing and the cast housing.

16. The pinion housing of claim 14 wherein the tube housing has a greater material unit weight than the cast housing.

17. The pinion housing of claim 14 wherein the stamped and tube housings are formed from steel and the cast housing is formed from aluminum.

18. The pinion housing of claim 14 further comprising:
a steering member disposed in the tube housing;
a pinion disposed in the cast housing, wherein the pinion is operatively connected to a rack portion of the steering member; and
a pulley assembly disposed in the stamped housing, wherein the pulley assembly operatively connects a power source to a ball nut assembly and the ball nut assembly is operatively connected to a screw portion of the steering member.
